(19) United States
(12) Patent Application Publication
(10) Pub. No.: US 2019/0184923 A1
(43) Pub. Date: Jun. 20, 2019

(54) VEHICLE IMPACT ABSORBING SYSTEM

(71) Applicant: FORD GLOBAL TECHNOLOGIES, LLC, Dearborn, MI (US)

(72) Inventors: Mohamed Ridha BACCOUCHE, Ann Arbor, MI (US); Rahul ARORA, Birmingham, MI (US); James Chih CHENG, Troy, MI (US); Jamel BELWAFA, Ann Arbor, MI (US)

(21) Appl. No.: 15/845,275

(22) Filed: Dec. 18, 2017

(51) Int. Cl. B60R 19/34

(52) U.S. Cl. CPC B60R 19/34; B60R 2019/262

(57) ABSTRACT

A vehicle includes a rail, a bumper, and an impact absorber. The rail defines a keyed orifice. The impact absorber has a primary tube secured to the rail and bumper. The impact absorber also has a secondary tube that is rotatably secured and concentric to the primary tube. The secondary tube has a radially extending protrusion. The secondary tube is configured to slide into the orifice during an impact when the protrusion and orifice are aligned and to engage the rail during an impact when the protrusion and orifice are not aligned.

### TECHNICAL FIELD

The present disclosure relates to vehicle safety structures that are configured to protect vehicle passengers during impact events.

### BACKGROUND

Vehicles may include structures that are designed to absorb energy in order to protect vehicle passengers during impact events.

### SUMMARY

A vehicle includes a rail, a bumper, and an impact absorber. The rail defines a keyed orifice. The impact absorber has a primary tube secured to the rail and bumper. The impact absorber also has a secondary tube that is rotatably secured and concentric to the primary tube. The secondary tube has a radially extending protrusion. The secondary tube is configured to slide into the orifice during an impact when the protrusion and orifice are aligned and to engage the rail during an impact when the protrusion and orifice are not aligned.

A vehicle includes a primary impact absorbing tube, a secondary impact absorbing tube, and a controller. The primary impact absorbing tube is secured to and extends between a rail and a bumper. The secondary impact absorbing tube is rotatably secured and concentric to the primary tube. The secondary tube has a radially extending protrusion. The secondary tube is configured to slide into a keyed orifice defined by the rail during an impact when the protrusion and orifice are aligned and to engage the rail during an impact when the protrusion and orifice are not aligned. The controller is programmed to, in response to vehicle speed exceeding a first threshold, rotate the secondary tube such that the protrusion and orifice are not aligned.

A vehicle impact absorbing system includes a first tube and a second tube. The first tube is secured to a rail and a bumper at opposing ends. The second tube is rotatably secured and concentric to the primary tube. The second tube has a radially extending protrusion. The second tube is configured to slide into a keyed orifice defined by the rail during an impact when the protrusion and orifice are aligned and to engage the rail during an impact when the protrusion and orifice are not aligned.

### BRIEF DESCRIPTION OF THE DRAWINGS

FIG. 1 is a schematic illustration of a representative vehicle;

FIG. 2 is a plan view of a vehicle bumper, an impact absorber, and a frame rail;

FIG. 3 is a perspective view of a portion of the impact absorber;

FIG. 4 is a cutaway partial perspective view of a first embodiment of the impact absorber;

FIG. 5A is a cross-sectional view taken along line 5-5 in FIG. 4 with an interior tube of the impact absorber in a first alignment position;

FIG. 5B is a cross-sectional view taken along line 5-5 in FIG. 4 with an interior tube of the impact absorber in a second alignment position;

FIG. 6 is a partial cross-sectional view of a second embodiment of the impact absorber taken along line 6-6 in FIG. 2;

FIG. 7A is a cross-sectional view of the second embodiment of the impact absorber taken along line 7-7 in FIG. 2 with a pair of interior tubes of the impact absorber in first alignment positions;

FIG. 7B is a cross-sectional view of the second embodiment of the impact absorber taken along line 7-7 in FIG. 2 with the pair of interior tubes of the impact absorber in second alignment positions; and

FIG. 7C is a cross-sectional view of the second embodiment of the impact absorber taken along line 7-7 in FIG. 2 with the pair of interior tubes of the impact absorber in third alignment positions.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

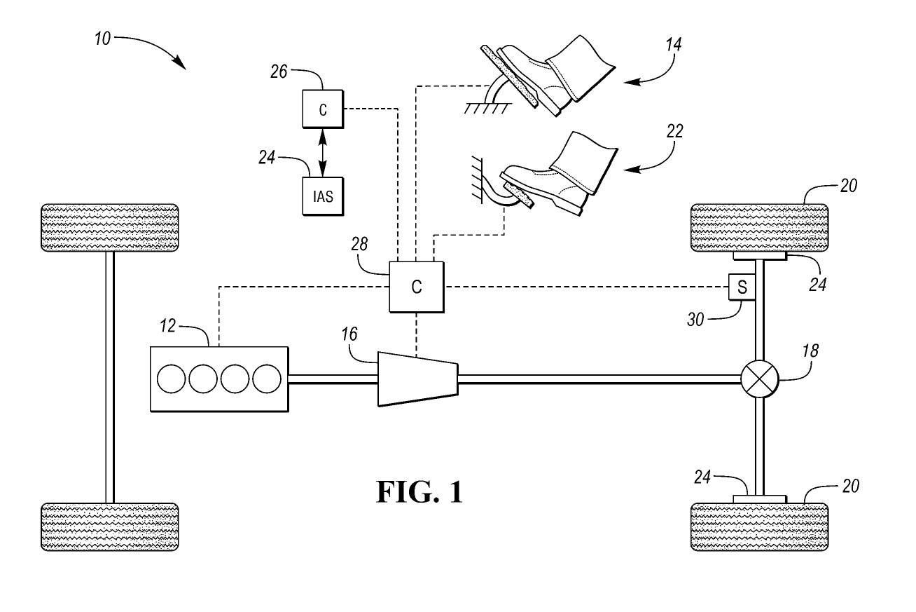

Referring to FIG. 1, a representative vehicle 10 is illustrated. The vehicle 10 includes a powertrain. The powertrain may include a power generator that is configured to generate torque and power within the powertrain, such as an internal combustion engine 12. The vehicle operator may request a desired torque and/or power output of the engine 12 by depressing an accelerator pedal 14. The powertrain may further include a gearbox 16, a differential 18, drive wheels 20, and various other components such as gears and/or driveshafts. For example, a torque converter or a launch clutch may be disposed between the engine 12 and the gearbox 16. The gearbox 16 may be a multi-ratio transmission that provides multiple gear ratios between the input and output of the gearbox 16. The vehicle may also include a brake pedal 22 that is configured to engage friction brakes 24 when applied to slow the vehicle 10 or prevent the wheels 20 from turning if the vehicle 10 is stationary.

The vehicle may also include an impact absorber (or impact absorbing system) 24. The impact absorber 24 may include a plurality of tubes (discussed in further detail below). Some of the tubes may be configured to transition (i.e., rotate) between two or more positions. In at least one position, an individual tube may be configured to engage a frame (or a particular component of the frame) of the vehicle 10 during an impact or collision of the vehicle 10 with another object, resulting in the tube crushing or compressing in order to absorb energy from the impact or collision. In at least one other position, an individual tube may be configured to slide into an orifice or void defined by the frame (or particular component thereof) during an impact or collision, resulting in the tube neither crushing nor compressing and absorbing little or no energy during the impact or collision. As the number of individual tubes that are positioned to engage the frame during an impact increases, the stiffness of the impact absorber will also increase.

One or more actuators 26, such as electric motors, may be configured to transition the tubes between the two or more positions. Multiple actuators may be included, such that a single actuator is be configured to transition an individual tube between two or more positions. Alternatively, a single actuator may transition two or more tubes between two or more positions. The tubes may be connected to the one or more actuators 26 by linking devices such as gears, shafts, pullies, etc.

A controller 28 may be in communication with and configured to control various subsystems of the vehicle 10 including the engine 12, the gearbox 16 (e.g., to shift the gearbox 16 between gears), and the actuators 26 based on various states or conditions of the vehicle 10. The vehicle 10 may include various sensors that communicate the various states or conditions of the vehicle 10 to the controller 28. For example, one or more vehicle speed sensors 30 may communicate the vehicle speed at the wheels 20 to the controller 28. The controller 28 may include an algorithm that converts the rotational speed of the wheels 20 to the linear speed of the vehicle 10.

While illustrated as one controller, the controller 28 may be part of a larger control system and may be controlled by various other controllers throughout the vehicle 10, such as a vehicle system controller (VSC). It should therefore be understood that the controller 28 and one or more other controllers can collectively be referred to as a “controller” that controls various actuators in response to signals from various sensors to control functions the vehicle 10 or vehicle subsystems. The controller 28 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 28 in controlling the vehicle 10 or vehicle subsystems.

Control logic or functions performed by the controller 28 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller 28. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

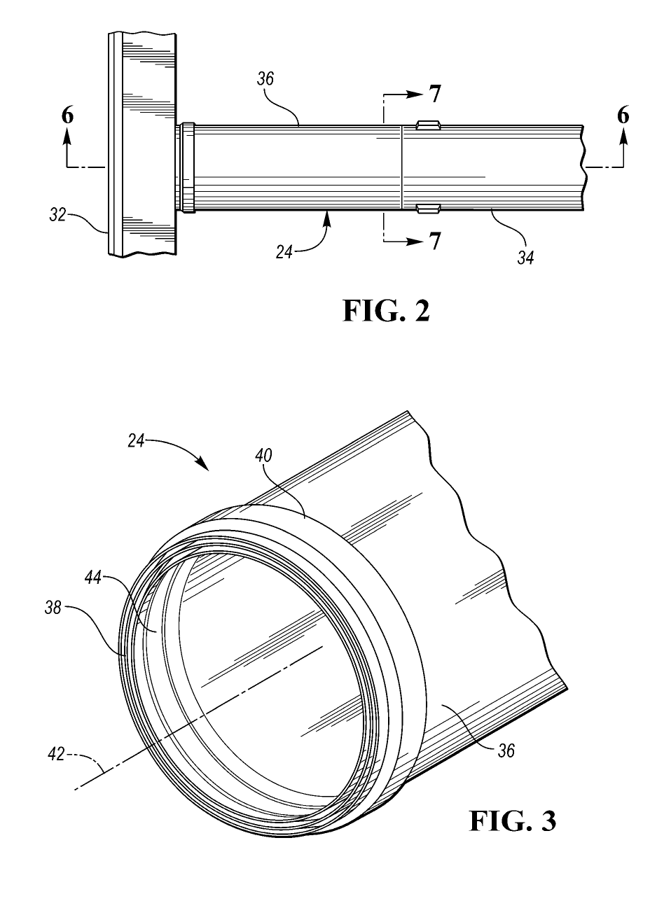

Referring to FIG. 2, a plan view of a vehicle bumper 32, the impact absorber 24, and a frame rail 34 are illustrated. The impact absorber 24 extends between the bumper 32 and the frame rail 34. The impact absorber 24 is secured to both the bumper 32 and the frame rail 34. More specifically, opposing ends of a primary (or first) impact absorbing tube 36 of the impact absorber 24 are respectively secured to the bumper 32 and the frame rail 34. The primary tube 36 may also be referred to as the exterior tube. The impact absorber 24 may include additional impact absorbing tubes that that are disposed within the primary tube 36. Therefore, it should be understood that FIG. 2 may be representative of one or more embodiments of an impact absorber 24 that includes an exterior impact absorbing tube and one or more interior impact absorbing tubes that are disposed within the primary tube 36.

Referring to FIG. 3, a perspective view of a portion of the impact absorber 24 is illustrated. A secondary (or second) tube 38 is disposed within the primary tube 36. The secondary tube 38 is concentric with the primary tube 36. The secondary tube 38 is rotatably secured to the primary tube 36. The secondary tube 38 may be rotatably secured to the primary tube 36 by a manufacturing operation that deforms the primary tube 36 and secondary tube 38 forming a radially protruding ridge 40. Once the secondary tube 38 is rotatably secured to the primary tube 36, the secondary tube 38 may rotate within the primary tube 36 about a longitudinal axis 42, but may be restricted in movement along the longitudinal axis 42 relative to the primary tube 36.

A tertiary (or third) tube 44 may be disposed within the secondary tube 38. The tertiary tube 44 is concentric with the secondary tube 38 and the primary tube 36. The tertiary tube 44 is rotatably secured to the secondary tube 38 and the primary tube 36. The tertiary tube 44 may be rotatably secured to the secondary tube 38 and primary tube 36 by a manufacturing operation that deforms the primary tube 36, secondary tube 38, and tertiary tube 44 to form the radially protruding ridge 40. Once the tertiary tube 44 is rotatably secured to the secondary tube 38 and the primary tube 36, the tertiary tube 44 may rotate within the secondary tube 38 and the primary tube 36 about the longitudinal axis 42, but may be restricted in movement along the longitudinal axis 42 relative to the secondary tube 38 and the primary tube 36. Although FIG. 3 illustrates an impact absorber having three concentric tubes that are rotatably secured to each other, it should be understood that the impact absorber may have two or more concentric tubes that are rotatably secured to each other.

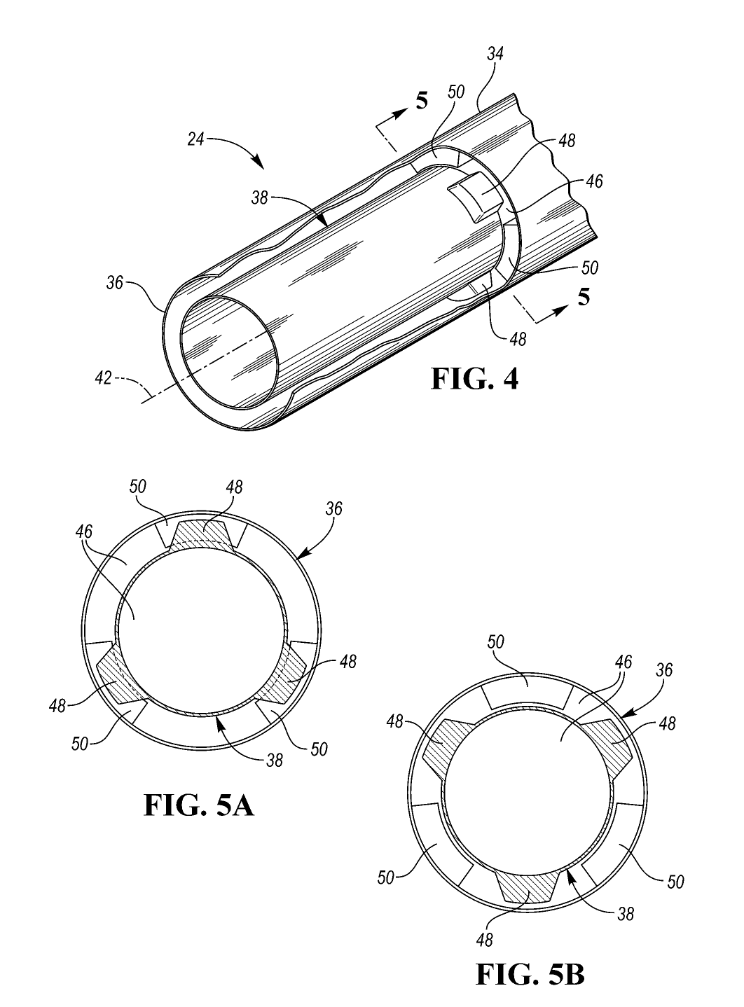

Referring to FIGS. 4, 5A, and 5B, a first embodiment of the impact absorber 24 is illustrated. The first embodiment of the impact absorber 24 only includes the primary tube 36 and the secondary tube 38. A portion of the primary tube 36 has been removed for illustrative purposes. The frame rail 34 is shown to be affixed to the primary tube 36. Therefore, the primary tube 36 will engage the frame rail 34 during all impacts or collisions, resulting in the primary tube 36 crushing or compressing in order to absorb energy from such impacts or collisions. The frame rail 34 defines a keyed orifice (or gateway) 46. The secondary tube 38 includes at least one radially outward extending protrusion 48 (which may alternatively be referred to as a first protrusion or a first set of protrusions). The keyed orifice 46 is partially defined by at least one radially inward extending blocker 50. The blockers 50 may be secured to or may be an integral portion of the frame rail 34, as shown in FIGS. 4-5B. Alternatively, however, the blockers 50 may be secured to or may be an integral portion of the primary tube 36, as long as the blockers 50 are spatially positioned closer to the frame rail 34 relative to the radially extending protrusions 48 and as long as there is at least a small gap between the radially extending protrusions 48 and the blockers 50 along the longitudinal axis 42 such that the secondary tube 38 may rotate within the primary tube 36 prior to an occurrence of any vehicle collision or impact.

Referring specifically to FIG. 5A, the secondary tube 38 is shown to be rotated to a position where the radially extending protrusions 48 are aligned with the blockers 50 (i.e., not aligned with the keyed orifice 46). When the radially extending protrusions 48 are aligned with the blockers 50, the secondary tube 38 is configured to engage the frame rail 34 during an impact (via the radially extending protrusions 48 engaging blockers 50), resulting in the secondary tube 38 crushing or compressing in order to absorb energy from the impact or collision. It should be noted that if the blockers 50 are affixed to the primary tube 36, the secondary tube 38 indirectly engages the frame rail 34 through the blockers 50 and primary tube 36.

Referring specifically to FIG. 5B, the secondary tube 38 is shown to be rotated to a position where the radially extending protrusions 48 are aligned with the keyed orifice 46 (i.e., not aligned with the blockers 50). When the radially extending protrusions 48 are aligned with the keyed orifice 46, the secondary tube 38 is configured to slide into the keyed orifice 46 during an impact or collision, resulting in the secondary tube 38 neither crushing nor compressing and absorbing little or no energy from the impact or collision.

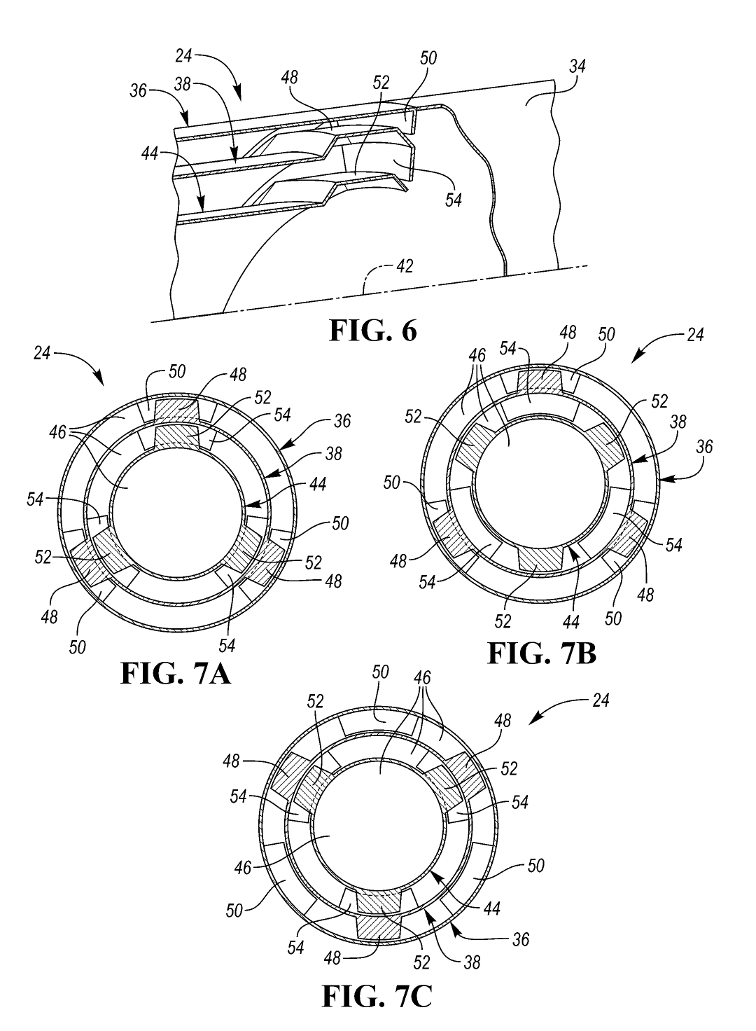

Referring to FIGS. 6, 7A, 7B and 7C, a second embodiment of the impact absorber 24 is illustrated. The second embodiment of the impact absorber 24 includes the primary tube 36, secondary tube 38, the radially extending protrusions 48 of the secondary tube 38, and the blockers 50. Again, the frame rail 34 is shown to be affixed to the primary tube 36. Therefore, the primary tube 36 will engage the frame rail 34 during all impacts or collisions, resulting in the primary tube 36 crushing or compressing in order to absorb energy from such impacts or collisions. The components of the second embodiment of the impact absorber 24 that are common to the first embodiment depicted FIGS. 4-5B should be construed to have the same physical characteristics and functions unless otherwise described herein. For example, the blockers 50 are shown to be secured to or as an integral portion of the primary tube 36 in FIGS. 6-7C. However, it should be understood that the blockers 50 may be secured to or may be an integral portion of the frame rail 34 as described above with respect to the first embodiment of the absorber 34. It should further be noted that keyed orifice 46 is partially defined by blockers 50 regardless if the blockers 50 are secured to the primary tube 36 or the frame rail 34.

The second embodiment of the impact absorber 24 also includes the tertiary tube 44. The tertiary tube 44 includes at least one radially outward extending protrusion 52 (which may alternatively be referred to as a second protrusion or a second set of protrusions). The secondary tube 38 may include at least one radially inward extending blocker 54. The blockers 54 may be secured to or may be an integral portion of the secondary tube 38. The blockers 54 are spatially positioned closer to the frame rail 34 relative to the radially extending protrusions 52 and there is at least a small gap between the radially extending protrusions 52 and the blockers 54 along the longitudinal axis 42 such that the tertiary tube 44 may rotate within the secondary tube 38 prior to an occurrence of any vehicle collision or impact.

Referring specifically to FIG. 7A, the secondary tube 38 is shown to be rotated to a position where the radially extending protrusions 48 are aligned with the blockers 50 (i.e., not aligned with the keyed orifice 46) and the tertiary tube 44 is shown to be rotated to a position where the radially extending protrusions 52 are aligned with the blockers 54 (i.e., not aligned with the keyed orifice 46). When the radially extending protrusions 48 of the secondary tube 38 are aligned with the blockers 50 and the radially extending protrusions 52 of the tertiary tube 44 are aligned with the blockers 54, the secondary tube 38 and the tertiary tube 44 are both configured to engage the frame rail 34 during an impact (via the radially extending protrusions 48 engaging blockers 50 and the radially extending protrusions 52 engaging blockers 54), resulting in both the secondary tube 38 and the tertiary tube 44 (in addition to the primary tube 36) crushing or compressing in order to absorb energy from the impact or collision. The tertiary tube 44 indirectly engages the frame rail 34 through the blockers 54 and secondary tube 38. It should be noted that if the blockers 50 are affixed to the primary tube 36, the secondary tube 38 indirectly engages the frame rail 34 through the blockers 50 and primary tube 36.

Referring specifically to FIG. 7B, the secondary tube 38 is shown to be rotated to a position where the radially extending protrusions 48 are aligned with the blockers 50 (i.e., not aligned with the keyed orifice 46) and the tertiary tube 44 is shown to be rotated to a position where the radially extending protrusions 52 are aligned with the keyed orifice 46 (i.e., not aligned with the blockers 54). When the radially extending protrusions 48 of the secondary tube 38 are aligned with the blockers 50 and the radially extending protrusions 52 of the tertiary tube 44 are aligned with the keyed orifice 46, the secondary tube 38 is configured to engage the frame rail 34 during an impact (via the radially extending protrusions 48 engaging blockers 50) and the tertiary tube 44 is configured to slide into the keyed orifice 46 during an impact, resulting in the secondary tube 38 (in addition to the primary tube 36) crushing or compressing in order to absorb energy from the impact or collision and the tertiary tube 44 neither crushing nor compressing and absorbing little or no energy from the impact or collision.

Referring specifically to FIG. 7C, the secondary tube 38 is shown to be rotated to a position where the radially extending protrusions 48 are aligned with the keyed orifice 46 (i.e., not aligned with the blockers) and the tertiary tube 44 is shown to be rotated to a position where the radially extending protrusions 52 are aligned with the blockers 54 (i.e., not aligned with the keyed orifice 46). When the radially extending protrusions 48 of the secondary tube 38 are aligned with the keyed orifice 46, the secondary tube 38 and the tertiary tube 44 are both configured to slide into the keyed orifice 46 during an impact, resulting in both the secondary tube 38 and the tertiary tube 44 neither crushing nor compressing and absorbing little or no energy from the impact or collision. It should be noted that the tertiary tube 44 is configured to slide into the keyed orifice 46 as long as the radially extending protrusions 48 of the secondary tube 36 are aligned with the keyed orifice 46, regardless if the radially extending protrusions 52 are aligned with the blockers 54 or the keyed orifice 46.

Referring back to FIG. 1, the controller 28 may be programmed to incrementally increase the stiffness of the impact absorber 24 (and therefore the ability of impact absorber 24 to absorb energy) as vehicle speed (and therefore kinetic energy of the vehicle) increases. In an embodiment that includes the primary tube 36 and the secondary tube 38, the controller 28 may be programmed to, in response to vehicle speed increasing to a value that exceeds a first threshold, rotate the secondary tube 38 via the actuator 26 such that the radially extending protrusions 48 are aligned with the blockers 50 (i.e., not aligned with the keyed orifice 46), which will increase the stiffness of the impact absorber 24. The controller 28 may also be programmed to, in response to vehicle speed decreasing to a value that is less than the first threshold, rotate the secondary tube 38 via the actuator 26 such that the radially extending protrusions 48 are aligned with the keyed orifice (i.e., not aligned with the blockers 50), which will decrease the stiffness of the impact absorber 24.

In an embodiment that includes the primary tube 36, secondary tube 38, and tertiary tube 44, the controller 28 may be programmed to, in response to vehicle speed increasing to a value that is greater than the first threshold but less than a second threshold, adjust the secondary tube 38 and the tertiary tube 44 to a first configuration. The first configuration includes rotating the secondary tube 38 such that the radially extending protrusions 48 are aligned with the blockers 50 (i.e., not aligned with the keyed orifice 46) and rotating the tertiary tube 44 such that the radially extending protrusions 52 are aligned with the keyed orifice 46 (i.e., not aligned with the blockers 54).

The controller 28 may also be programmed to, in response to vehicle speed increasing to a value that is greater than the second threshold, adjust the secondary tube 38 and the tertiary tube 44 to a second configuration. The second configuration includes rotating the secondary tube 38 such that the radially extending protrusions 48 are aligned with the blockers 50 (i.e., not aligned with the keyed orifice 46) and rotating the tertiary tube 44 such that the radially extending protrusions 52 are aligned with the blockers 54 (i.e., not aligned with the keyed orifice 46). The stiffness of the impact absorber 24 in the second configuration is greater than the stiffness of the impact absorber 24 in the first configuration.

The controller 28 may be further programmed to, in response to vehicle speed decreasing to a value that is less than the first threshold, adjust the secondary tube 38 and the tertiary tube 44 to a third configuration. The third configuration includes rotating the secondary tube such 38 that the radially extending protrusions 48 are aligned with the keyed orifice 46 (i.e., not aligned with the blockers 50). The radially extending protrusions 52 of the tertiary tube 44 may be either aligned with the blockers 54 or the keyed orifice 46 in the third configuration. The stiffness of the impact absorber 24 in the third configuration is less than the stiffness of the impact absorber 24 in the first configuration.

Although the impact absorbing device depicted herein included an external tube and either one or two internal tubes that could be rotated to different positions to either increase or decrease the stiffness of an impact absorber, the disclosure should be construed to include impact absorbing devices that include an external tube and one or more internal tubes whose positions may be adjusted to incrementally increase or decrease the stiffness of the impact absorber.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

1. A vehicle comprising:
a rail defining a keyed orifice;
a bumper; and
an impact absorber having,
a primary tube secured to the rail and bumper, and
a secondary tube rotatably secured and concentric to the primary tube, having a radially extending protrusion, configured to slide into the orifice during an impact when the protrusion and orifice are aligned and to engage the rail during an impact when the protrusion and orifice are not aligned.

2. The vehicle of claim 1 further comprising a controller programmed to, in response to vehicle speed increasing to a first value that is greater than a threshold, rotate the secondary tube such that the protrusion and orifice are not aligned.

3. The vehicle of claim 2, wherein the controller is further programmed to, in response to vehicle speed decreasing to a second value that is less than the threshold, rotate the secondary tube such that the protrusion and orifice are aligned.

4. The vehicle of claim 3 further comprising an electric motor configured to rotate the secondary tube.

5. The vehicle of claim 1, wherein the impact absorber further comprises a tertiary tube rotatably secured and concentric to the secondary tube, disposed within the secondary tube, having a second radially extending protrusion, and configured to slide into the orifice during an impact when the protrusion and orifice are aligned and to engage the rail during an impact when the both the protrusion and the second protrusion are not aligned with the orifice.

6. The vehicle of claim 5 further comprising a controller programmed to, in response to vehicle speed increasing to a first value that is greater than a first threshold but less than a second threshold, rotate the secondary tube such that the protrusion and orifice are not aligned and rotate the tertiary tube such that the second protrusion and orifice are aligned.

7. The vehicle of claim 6, wherein the controller is further programmed to, in response to vehicle speed increasing to a second value that is greater than the second threshold, rotate the secondary tube such that the protrusion and orifice are not aligned and rotate the tertiary tube such that the second protrusion and orifice are not aligned.

8. The vehicle of claim 6, wherein the controller is further programmed to, in response to vehicle speed decreasing to a second value that is less than the first threshold, rotate the secondary tube such that the protrusion and orifice are aligned.

9. A vehicle comprising:
a primary impact absorbing tube secured to and extending between a rail and a bumper;
a secondary impact absorbing tube rotatably secured and concentric to the primary tube, having a radially extending protrusion, configured to slide into a keyed orifice defined by the rail during an impact when the protrusion and orifice are aligned and to engage the rail during an impact when the protrusion and orifice are not aligned; and
a controller programmed to, in response to vehicle speed exceeding a first threshold, rotate the secondary tube such that the protrusion and orifice are not aligned.

10. The vehicle of claim 9 wherein the controller is further programmed to, in response to vehicle speed decreasing to a second value that is less than the first threshold, rotate the secondary tube such that the protrusion and orifice are aligned.

11. The vehicle of claim 9, wherein the impact absorber further comprises a tertiary impact absorbing tube rotatably secured and concentric to the primary and secondary tubes, having a second radially extending protrusion, and configured to slide into the orifice during an impact when the protrusion and orifice are aligned and to engage the rail during an impact when the both the protrusion and the second protrusion are not aligned with the orifice.

12. The vehicle of claim 11, wherein the controller is further programmed to, in response to vehicle speed increasing to a first value that is greater than the first threshold but less than a second threshold, rotate the secondary tube such that the protrusion and orifice are not aligned and rotate the tertiary tube such that the second protrusion and orifice are aligned.

13. The vehicle of claim 12, wherein the controller is further programmed to, in response to vehicle speed increasing to a second value that is greater than the second threshold, rotate the secondary tube such that the protrusion and orifice are not aligned and rotate the tertiary tube such that the second protrusion and orifice are not aligned.

14. The vehicle of claim 12, wherein the controller is further programmed to, in response to vehicle speed decreasing to a second value that is less than the first threshold, rotate the secondary tube such that the protrusion and orifice are aligned.

15. The vehicle of claim 9 further comprising an electric motor configured to rotate the secondary tube.

16. A vehicle impact absorbing system comprising:
a first tube secured to a rail and a bumper at opposing ends; and
a second tube rotatably secured and concentric to the first tube, having a radially extending protrusion, configured to slide into a keyed orifice defined by the rail during an impact when the protrusion and orifice are aligned and to engage the rail during an impact when the protrusion and orifice are not aligned.

17. The system of claim 16 further comprising a controller programmed to, in response to vehicle speed increasing to a first value that is greater than a threshold, rotate the second tube such that the protrusion and orifice are not aligned.

18. The system of claim 17, wherein the controller is further programmed to, in response to vehicle speed decreasing to a second value that is less than the threshold, rotate the second tube such that the protrusion and orifice are aligned.

19. The system of claim 18 further comprising an electric motor configured to rotate the second tube.

20. The system of claim 16, wherein the impact absorber further comprises a third tube rotatably secured and concentric to the first and second tubes, having a second radially extending protrusion, and configured to slide into the orifice during an impact when the protrusion and orifice are aligned and to engage the rail during an impact when the both the protrusion and the second protrusion are not aligned with the orifice.
